(19) United States
(12) Patent Application Publication
(10) Pub. No.: US 2025/0094927 A1
(43) Pub. Date: Mar. 20, 2025

(54) WORKFLOW MANAGEMENT DEVICE AND WORKFLOW MANAGEMENT METHOD

(71) Applicant: Hitachi Industry & Control Solutions, Ltd., Tokyo (JP)

(72) Inventor: Haruka SUDO, Tokyo (JP)

(21) Appl. No.: 18/818,846

(22) Filed: Aug. 29, 2024

(30) Foreign Application Priority Data
Sep. 15, 2023 (JP) 2023-149759

(51) Int. Cl. G06Q 10/10

(52) U.S. Cl. CPC G06Q 10/103

(57) ABSTRACT

A workflow management device includes an input/output processing part and a workflow management part. The input/output processing part is configured to receive workflow information and interlock information. The workflow information is information on a workflow of a document from drafting to approval. The interlock information is information that sets in advance whether an operation on the document is to be denied due to an interlock. The workflow management part is configured to receive an operation on the document while the workflow is in progress based on the workflow information, and determine whether the received operation is to be denied due to an interlock by referencing the interlock information.

### CROSS-REFERENCE STATEMENT

The present application is based on, and claims priority from, Japan Application Serial Number 2023-149759, filed Sep. 15, 2023, the disclosure of which is hereby incorporated by reference herein in its entirety.

### BACKGROUND

### Technical Field

The disclosure relates to a workflow management device and a workflow management method.

### Related Art

Managing a process of reaching a decision on a document in an organization by a computer has become common in recent years. A workflow device of Patent Literature 1 (Japanese Unexamined Patent Application Publication No. 2023-28542) circulates a document that has been proposed by an applicant to multiple approvers according to a preset path of approval. The workflow device sets a certain point on the approval path as a stopping point. When the workflow progresses to the stopping point, the workflow device suspends the workflow at the stopping point.

In an actual decision reaching process, many people will be involved with a document before a final decision on the document is reached in an organization. Not everyone may be equally involved in a document. A type of operation (revising, viewing, etc.) that may be performed on a document will vary depending on the contents of the document, a role of a person, or the like. A mechanism (an interlock) is required to set in advance an operation that a certain person may not perform and prohibit the person from performing the operation when the person attempts to perform the operation. Without this mechanism, a person who is not expected to view or revise a document will be able to do so before a final decision is reached for the document and, as a result, work may stagnate, an accident may occur, or the like.

The workflow device of Patent Literature 1 stops the workflow immediately after a predetermined approver approves the document to prevent, for example, a contract from being inadvertently leaked to an external organization. However, the workflow device of Patent Literature 1 is focused on stopping the workflow and is not concerned with an interlock.

### SUMMARY

An aspect of the disclosure is directed to a workflow management device that includes a processor. The processor is configured to receive workflow information and interlock information. The workflow information is information on a workflow of a document from drafting to approval. The interlock information is information that sets in advance whether an operation on the document is to be denied due to an interlock. The processor is configured to receive an operation on the document while the workflow is in progress based on the workflow information, and to determine whether the received operation is to be denied due to an interlock by referencing the interlock information.

### BRIEF DESCRIPTION OF DRAWINGS

FIG. 1 is a diagram showing a configuration of a workflow management device.

FIG. 2 is an example of workflow information.

FIG. 3 is an example of interlock information.

FIG. 4 is an example of progress information.

FIG. 5 is an example of affiliation information.

FIG. 6 is a flowchart of a passing-on-document procedure.

FIG. 7 is a flowchart of an interlock processing procedure.

FIG. 8 is a flowchart of a workflow participation procedure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Hereinafter, an embodiment of the disclosure (hereinafter “the present embodiment”) will be described in detail with reference to the drawings. The present embodiment is an example of reaching a decision on a document in a general company. However, the disclosure may be applied to cases where a final decision on a document is to be reached with the involvement of multiple people in a non-corporation setting such as a government office, school, or medical institution. Further, the disclosure may be generally applied to cases where a record of tasks by multiple people is stored in an area of a computer, even if something specifically named a “document” is not created.

### Terms

A user is a person who is permitted to access a workflow management device. Users are often affiliated to the same organization, and a user may have a hierarchical relationship (superior/subordinate relationship) with another user.

A workflow is a rule that sets in advance an order in which multiple users perform work. In the case of office work, work is accomplished through a flow of drafting and approving a document. In this case, a workflow is a sequence in which the document is passed on among multiple users.

To pass on a document may refer to sending the document to the next approver by attaching the document to an email or the like. To pass on a document may refer to storing the document in a specific storage area of the workflow management device and sending an email to the next approver with an instruction to access the document via a network or the like.

A document is, for example, a file that contains a work document, such as a written proposal, minute, contract, specification, or design document, in digitized form. The document includes any of or a combination of the following: a character string, a number, audio data, a music, or an image. In the present embodiment, in order to simplify the description, there is a one-to-one correspondence between the document and the workflow.

An operation is an action that a user performs on a document. Examples of types of operations include revising a document, copying a document, and viewing a document (details will be described later). Other types of operations may include filtering of audio or music data (deleting a high frequency part, etc.), changing a pixel value of an image (to change brightness), or the like. In this way, the operation corresponds to a general function of a computer. In the present embodiment, the operation is a concept that is different from each process of the workflow, such as drafting and approval, which will be described later.

Drafting is when a user creates a document in its original form. Such a user is also called a drafter. There is usually one drafter to one document.

Approval is when a user approves the content of the document. Such a user is also called an approver. An approver of a particular document is set in advance from users other than the drafter of the document. There are usually multiple approvers for one document. When all approvers who have been set in advance approve a particular document, a decision on the document by an organization is considered to have been reached.

An approver may pass on a document to the next approver after adding an instruction, a comment, or the like that does not contradict with the content of the document. Unless specifically prohibited, an approver may revise the content of the document and pass on the revised document to the next approver. Processes that are opposite to approval include returning and rejection.

Returning is when an approver instructs a drafter to revise a document and decides on an approver (said approver or another approver) to whom the revised document is to be passed on. The drafter who is instructed to make the revision may be a drafter other than the drafter of the document.

Rejection is when an approver halts a workflow related to a document.

To deny due to an interlock means prohibiting an operation by a user. An interlock is set in advance for a time period, a type of operation, or a user. A typical example of a time period is “before a decision is reached on the document”. A typical example of a type of operation that is to be prohibited is “revising a document”.

### Workflow Management Device

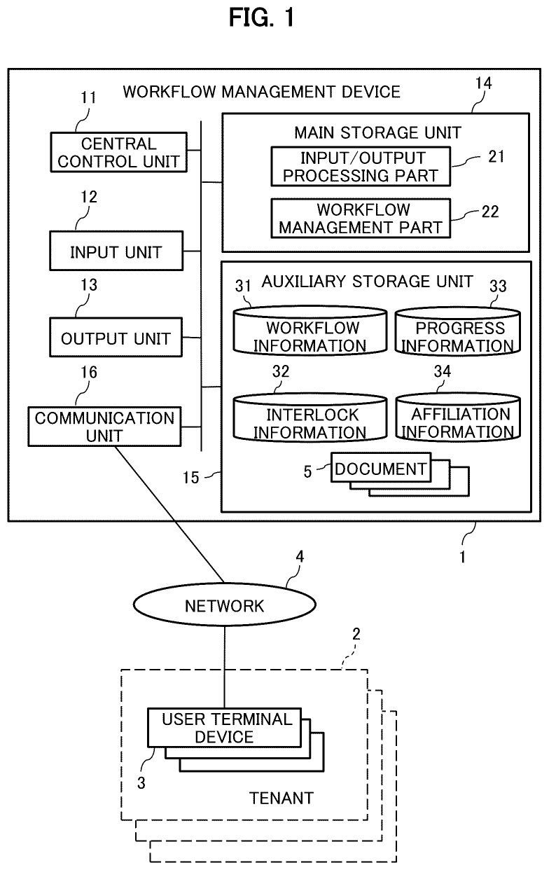

FIG. 1 is a diagram showing a configuration of a workflow management device 1. The workflow management device 1 is a general computer and includes a central control unit 11, an input unit 12 such as a mouse or keyboard, an output unit 13 such as a display, a main storage unit 14, an auxiliary storage unit 15, and a communication unit 16.

An input/output processing part 21 and a workflow management part 22 in the main storage unit 14 are programs. In the description that follows, when a given subject is a component whose name ends with “part”, it means that the central control unit 11 loads that program from the auxiliary storage unit 15 and into to the main storage unit 14 and implements a function of that program. The auxiliary storage unit 15 stores therein workflow information 31, interlock information 32, progress information 33, and affiliation information 34 (details will be described later). The auxiliary storage unit 15 may be configured independently in a separate casing.

There are multiple tenants 2. A tenant 2 is an organization such as a business entity that may access one workflow management device 1. Each tenant 2 has exclusive use of an area of the workflow management device 1 with a different physical address or logical address. In other words, security is maintained between the tenants 2.

Each tenant 2 includes multiple user terminal devices 3. Each user terminal device 3 is operated by an employee or the like (a user) affiliated to the tenant 2. Each user terminal device 3 is connected to the workflow management device 1 via a network 4. The auxiliary storage unit 15 stores a document 5 therein. A user accesses the workflow management device 1 via the user terminal device 3 and performs an operation such as viewing or revising the document 5.

### Workflow Information

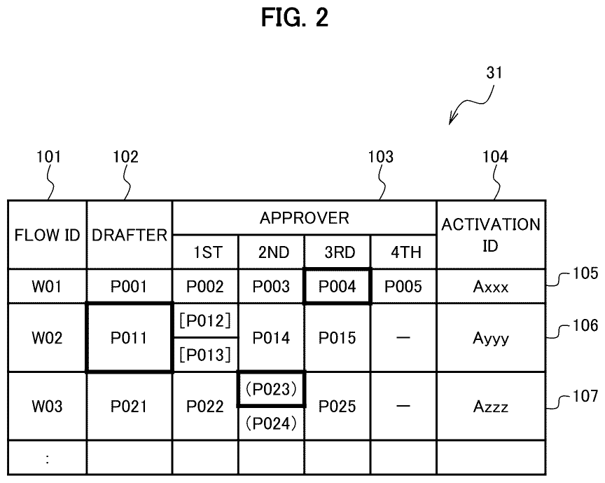

FIG. 2 is an example of the workflow information 31. In the workflow information 31, in association with a flow ID stored in a flow ID column 101, a drafter ID is stored in a drafter column 102, an approver ID is stored in an approver column 103, and an activation ID is stored in an activation ID column 104.

The flow ID in the flow ID column 101 is an identifier that uniquely identifies a workflow. In the present embodiment, the flow ID also uniquely identifies a document 5 that is drafted and approved in that workflow.

The drafter ID in the drafter column 102 is an identifier that uniquely identifies a drafter.

The approver ID in the approver column 103 is an identifier that uniquely identifies an approver. “1st”, “2nd”, “3rd”, “4th”, etc., are positions in an order of approval. There are multiple approvers for one workflow, and each approver is assigned a position in the order of approval. Multiple approver IDs may be associated with the same position in the order of approval. Here, brackets “[” and “]” indicate that multiple approvers of a position in the order of approval is overlapping; that is, approval from all approvers are required. Here, parentheses “(” and “)” indicate that multiple approvers of a position in the order of approval is selective; that is, approval from any one approver is sufficient. A thick-line border surrounding a drafter ID or an approver ID indicates that that drafter or approver is currently drafting or approving the document 5.

The activation ID in the activation ID column 104 will be described later.

The following may be observed from record 105 shown in FIG. 2.
Drafter P001 drafts a document 5.
There are four approvers for approving the document 5.
The document 5 is passed on to be approved in the following order of approval: approver P002→approver P003→approver P004→approver P005.
The document 5 is currently being approved by approver P004.

The following may be observed from record 106 shown in FIG. 2.
Drafter P011 drafts a document 5.
There are four approvers for approving the document 5.
The document 5 is passed on to be approved in the following order of approval: approver P012 and approver P013→approver P014→approver P015.
The document 5 is passed on to approver P012 and approver P013 at the same timing. After the document 5 is approved by both approver P012 and approver P013, the document 5 is passed on to approver P014.
Currently, the document 5 is being drafted by drafter P011.

The following may be observed from record 107 shown in FIG. 2.
Drafter P021 drafts a document 5.
There are four approvers for approving the document 5.
The document 5 is passed on to be approved in the following order of approval: approver P022→approver P023 or approver P024→approver P025.
The document 5 is passed on to approver P023 and approver P024 at the same timing. After the document 5 is approved by either approver P023 or approver P024, the document 5 is passed on to approver P025.
Currently, the document 5 is being approved by approver P023.
A message stating that “approval is not necessary” is sent to approver P024.

### Interlock Information

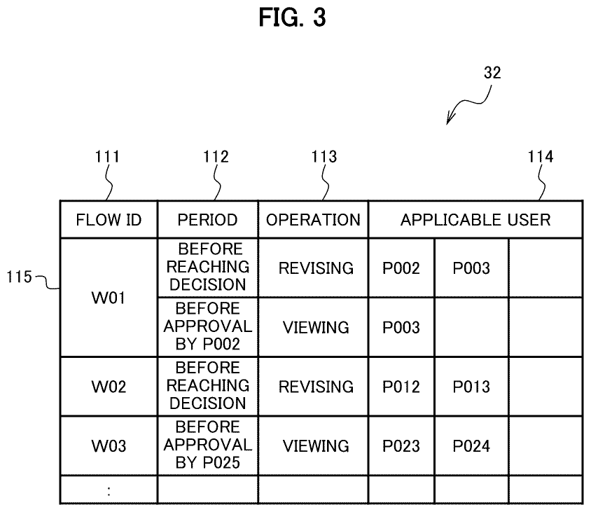

FIG. 3 is an example of the interlock information 32. In the interlock information 32, in association with a flow ID stored in a flow ID column 111, a time period is stored in a period column 112, an operation is stored in an operation column 113, and an applicable user ID is stored in an applicable user column.

The flow ID in the flow ID column 111 is the same as the flow ID in FIG. 2.

The time period in the period column 112 is a timing when an operation is denied due to an interlock.

An operation in the operation column 113 is an operation that may be denied due to an interlock. Examples of the operations include the following.
Viewing: Viewing a document 5.
Revising: Changing the contents of a document 5 (including partial deletion and addition) without a particular instruction.
Copying: Copying a document 5.
Passing on to another: Passing on a document 5 to someone other than users who have been set in a workflow.
Commenting: Adding a note to a document 5 without changing the contents of the document 5.
Adding a link: Adding a URL of reference information on the Internet or the like in a document 5.
Uploading: Uploading a document 5 onto the Internet.

The applicable user ID in the applicable user column 114 is an identifier that uniquely identifies a user to whom denying an operation due to an interlock is applicable. For example, the following may be observed from record 115 shown in FIG. 3.
In workflow W01, the approver P002 and approver P003 are prohibited from revising a document 5 during a period prior to a reaching of a decision (a period before the approver P005 approves the document 5).
In workflow W01, the approver P003 is prohibited from viewing the document 5 during a period prior to the approver P002 approving the document 5.

As is clear from the above, the interlock information 32 sets in advance whether or not an operation on a document 5 is to be denied due to an interlock.

### Progress Information

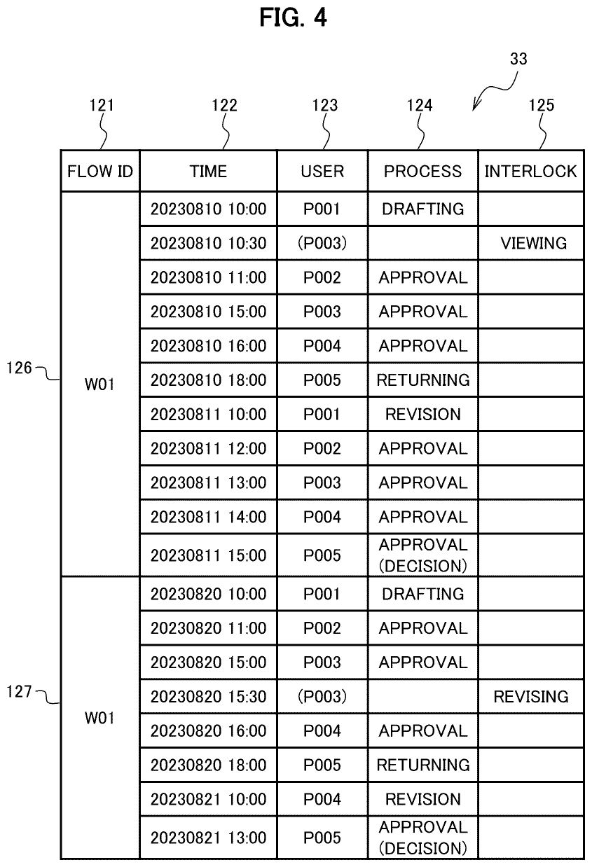

FIG. 4 is an example of progress information 33. In the progress information 33, in association with a flow ID stored in a flow ID column 121, a time column 122 stores a time, a user column 123 stores a user ID, a process column 124 stores a process, and an interlock column 125 stores an interlock flag.

The flow ID in the flow ID column 121 is the same as the flow ID in FIG. 2.

The time in the time column 122 is the time when a user executed a process for a workflow or the time when a user attempted to perform an operation that was locked due to an interlock.

The user in the user column 123 is an identifier that uniquely identifies a drafter or an approver. Parentheses “(” and “)” here indicate that an operation by that user was denied due to an interlock.

The process in the process column 124 is a process of the workflow that was executed by a user. In FIG. 4, processes “drafting”, “approval”, “revision”, “returning”, and “approval (decision)” are shown as examples, but another process may be used. Note that “revision” here refers to a process (re-drafting) that is based on an instruction of a user and performed by another user and differs from “revising” as an operation that is performed by a user without such a specific instruction.

The interlock flag in the interlock column 125 is an operation that was denied due to an interlock.

The following may be observed from record 126 shown in FIG. 4.
On Aug. 10, 2023, in workflow W01, approver P003 attempted to view a document 5 after drafter P001 drafted the document 5 but before approval by approver P002 . . . .
However, viewing the document 5 by approver P003 was denied due to an interlock. A purpose of the interlock here is that “approver P003 is not allowed to view the document 5 except when it is the turn of the approver P003 to approve the document 5”.
The basis for this denial due to an interlock is the record 115 shown in FIG. 3.
After approver P005 returned the document 5 to drafter P001, drafter P001 revised the document 5.

The following may be observed from record 127 shown in FIG. 4.
On Aug. 20, 2023, in workflow W01, approver P003 attempted to revise a document 5 after drafter P001 drafted the document 5 but before approval (decision) by approver P005.
However, revising the document 5 by the approver P003 was denied due to an interlock.
The basis for this denial due to an interlock is the record 115 shown in FIG. 3.
After approver P005 returned the document 5 to approver P004, approver P004 revised the document 5.

### Affiliation Information

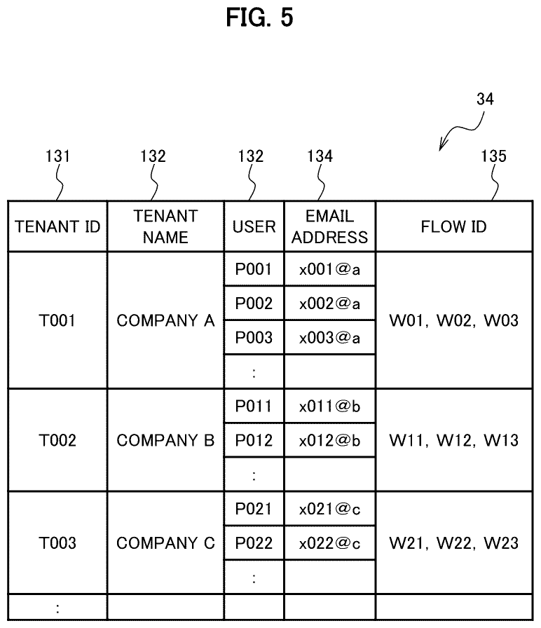

FIG. 5 is an example of affiliation information 34. In the affiliation information 34, in association with a tenant ID stored in a tenant ID column 131, a tenant name is stored in a tenant name column 132, a user ID is stored in a user column 133, an e-mail address is stored in an e-mail address column 134, and a flow ID is stored in a flow ID column 135.

The tenant ID in the tenant ID column 131 is an identifier that uniquely identifies a tenant 2 (an organization to which a user is affiliated).

The tenant name in the tenant name column 132 is a name of the tenant 2.

The user ID in the user column 133 is the same as the user ID in FIG. 4.

The email address in the email address column 134 is an email address of a user terminal device 3 operated by the user.

The flow ID in the flow ID column 135 is the same as the flow ID in FIG. 2.

The following may be observed from FIG. 5.
The workflow management device 1 is used by at least tenant company A, tenant company B, and tenant company C.
Multiple users are affiliated to each tenant.
A workflow to be managed differ for each tenant.

### Passing-On-Document Procedure

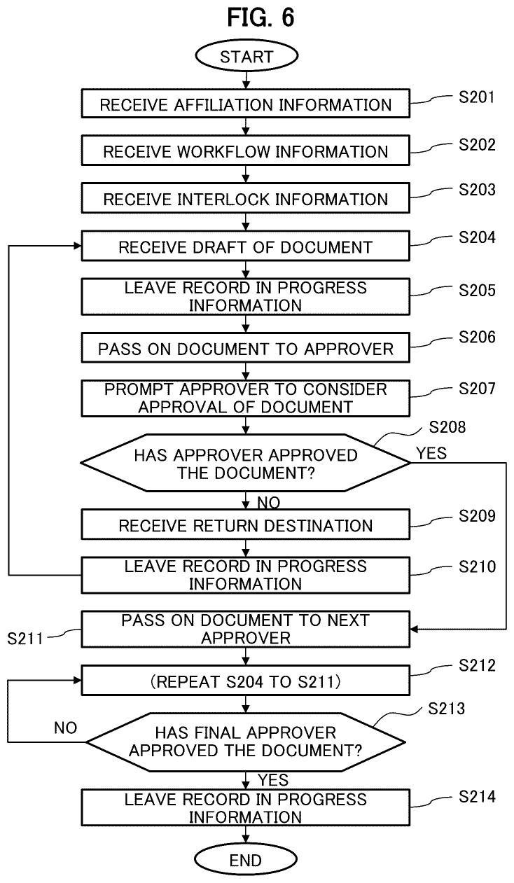

FIG. 6 shows a flowchart of a passing-on-document procedure.

In step S201, the input/output processing part 21 of the workflow management device 1 receives affiliation information 34 (FIG. 5). More specifically, first, the input/output processing part 21 receives a tenant name, user names, and email addresses from any user terminal device 3 belonging to a certain tenant 2.

Second, the input/output processing part 21 creates a record of the affiliation information 34 after assigning numbers to the tenant ID and user ID. At this stage, the flow ID column 135 of the affiliation information 34 is blank.

In step S202, the input/output processing part 21 receives workflow information 31 (FIG. 2). More specifically, first, the input/output processing part 21 receives a workflow from any user terminal device 3 belonging to the tenant 2. A format of the workflow does not matter as long as a name of a drafter, names of multiple approvers, an order of approval, and any overlapping or selective relationship are provided for each document 5 to be drafted.

Second, the input/output processing part 21 creates a record of the workflow information 31 based on the received workflow. At this stage, the input/output processing part 21 assigns numbers to the flow ID and activation ID (details will be described later) and stores the numbers in the record. The input/output processing part 21 stores the flow ID in the affiliation information 34.

The input/output processing part 21 may, for example, receive already complete workflow information 31 having the format shown in FIG. 2 from the user terminal device 3.

In step S203, the input/output processing part 21 receives interlock information 32 (FIG. 3). More specifically, first, the input/output processing part 21 receives a flow ID of a workflow as well as a time period, an operation, and an applicable user name of an interlock that is related to the workflow from any user terminal device 3 belonging to the tenant 2.

Second, the input/output processing part 21 creates a record of the interlock information 32 based on this information.

The input/output processing part 21 may, for example, receive already complete interlock information 32 having a format shown in FIG. 3 from the user terminal device 3.

In step S204, the workflow management part 22 of the workflow management device 1 receives a draft of a document 5. More specifically, first, the workflow management part 22 receives any document 5 from a user terminal device 3 of a drafter of the tenant 2. The document 5 here is, for example, a written proposal whose contents have been filled in (drafted). According to the workflow, multiple approvers are to approve the document 5 in a predetermined order of approval.

In step S205, the workflow management part 22 leaves a record in the progress information 33 (FIG. 4). More specifically, the workflow management part 22 records, for example, that a drafter “P001” has performed “drafting” of a document 5 for a workflow “W01” in the progress information 33. The workflow management part 22 surrounds “P001” of the drafter column 102 in the record 105 of the workflow information 31 (FIG. 2) with a thick line border during a period when the drafter P001 is providing a draft.

In step S206, the workflow management part 22 passes on the document 5 to an approver. More specifically, the workflow management part 22 passes on the document 5 to a user terminal device 3 of a first approver based on the workflow information 31. During a period when the first approver is approving the document, the workflow management part 22 surrounds, for example, “P002” of the approver column 103 in the record 105 of the workflow information 31 (FIG. 2) with a thick line border. During this period, the workflow management part 22 removes the thick line border that surrounded “P001”.

In step S207, the input/output processing part 21 prompts an approver to consider approval of the document 5. More specifically, the input/output processing part 21 displays a guidance message 5 on the user terminal device 3 of the next approver encouraging the next approver to consider approval of the document 5 that has been passed on.

In step S208, the workflow management part 22 determines whether the approver has approved the document 5. To keep the description simple, it is assumed that the approver inputs either “approve” or “return” as a result into the user terminal device 3 of the approver. If the result is “approve” (step S208, “YES”), the workflow management part 22 proceeds to step S211. If the result is “return” (step S208, “NO”), the process proceeds to step S209.

In step S209, the input/output processing part 21 receives a return destination. More specifically, the input/output processing part 21 receives an instruction from the user terminal device 3 of the approver who has given the “return” instruction as to which user the document 5 is to be returned for revision. In general, the document 5 is returned to the drafter.

In step S210, the workflow management part 22 leaves a record in the progress information 33 (FIG. 4). More specifically, first, the workflow management part 22 records, for example, that approver Pxxx has returned the document 5 to drafter P001 in workflow “W01” in the progress information 33.

Second, the workflow management part 22 passes on the document 5 that is to be revised to a user terminal device 3 of a drafter who is to revise the document 5. Subsequently, the workflow management part 22 returns to step S204. In step S204 to which the procedure has returned, the workflow management part 22 receives a revised document 5 from the user terminal device 3 of the drafter.

Although description is omitted from FIG. 6, the workflow management part 22 may pass on the document 5 that is to be revised to an approver who has once approved the document 5. In this case, the approver who has instructed the revision is different to the approver who has once approved the document 5.

In step S211, the workflow management part 22 passes on the document 5 to the next approver. The workflow management part 22 surrounds, for example, “P003” of the approver column 103 in the record 105 of the workflow information 31 (FIG. 2) with a thick line border during a period when the next approver is approving the document 5. During this period, the workflow management part 22 removes the thick line border surrounding “P002”.

In step S212, the workflow management part 22 repeats the processes of steps S204 to S211 as many times as necessary (as many times as the number of next approvers).

In step S213, the workflow management part 22 determines whether a final approver has approved the document 5. If the final approver has approved the document 5 (step S213, “YES”), the workflow management part 22 proceeds to step S214. Otherwise the workflow management part 22 returns to step S212 (step S213, “NO”).

In step S214, the workflow management part 22 leaves a record in the progress information 33 (FIG. 4). More specifically, the workflow management part 22 records, for example, that the last approver “P005” has given “approval (decision)” for the workflow “W01” in the progress information 33. Subsequently, the passing-on-document procedure ends.

### Interlock Processing Procedure

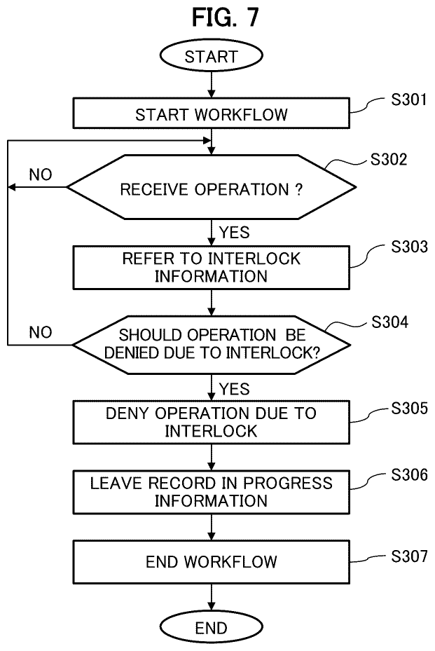

FIG. 7 is a flowchart of an interlock processing procedure.

In step S301, the workflow management part 22 of the workflow management device 1 starts a workflow. More specifically, the workflow management part 22 receives a draft of a document 5 from a user terminal device 3 of a drafter in an any workflow.

In step S302, the workflow management part 22 determines whether an operation has been received. The workflow management part 22 constantly monitors whether users perform an operation such as viewing or revising of a document 5 from respective positions of the users via a user terminal device 3. If the workflow management part 22 receives such an operation (step S302, “YES”), the workflow management part 22 proceeds to step S303. Otherwise, the workflow management part 22 remains on standby (step S302 “NO”).

In step S303, the workflow management part 22 refers to the interlock information 32 (FIG. 3). For example, if the workflow management part 22 receives an operation of “revising” the document 5 from approver “P003” in workflow “W01” during a period before a decision is reached, the operation should be denied by an interlock.

In step S304, the workflow management part 22 determines whether the operation should be denied due to an interlock. More specifically, if the received operation should be denied due to an interlock (step S304, “YES”), the workflow management part 22 proceeds to step S305. Otherwise (step S304 “NO”), the workflow management part 22 returns to step S302.

In step S305, the workflow management part 22 prevents the operation from being performed due to an interlock. More specifically, the workflow management part 22 invalidates the operation received in step S302 and displays a message like “the received operation has been denied due to an interlock” on a user terminal device 3 of a user who has performed the operation.

In step S306, the workflow management part 22 leaves a record in the progress information 33 (FIG. 4). More specifically, the workflow management part 22 records, for example, that “revising” of the document 5 by user “Pxxx” in workflow “W01” has been denied due to an interlock in the progress information 33.

In step S307, the workflow management part 22 ends the workflow. More specifically, the workflow management part 22 receives an approval (decision) of the document 5 by the last approver from a user terminal device 3 of the last approver. Subsequently, the interlock processing procedure ends.

### Tenant Management and Activation ID

The workflow management part 22 divides the workflow information 31 (FIG. 2), the interlock information 32 (FIG. 3), the progress information 33 (FIG. 4), and the document 5 according to each tenant 2 (an organization to which users belong). For example, storage of the auxiliary storage unit 15 is divided into an area A that stores the above-mentioned information that is related to a tenant “Company A”, an area B that stores the above-mentioned information that is related to a tenant “Company B”, and so on. These areas, area A, area B, and so on, are mutually exclusive areas with different physical addresses or logical addresses. The workflow management part 22 assigns an activation ID to an area of each tenant 2. The activation ID is an identifier that uniquely identifies such an exclusive area.

Normally, there is a one-to-one correspondence between a tenant 2 and an exclusive area for that tenant. That is, the tenant ID and activation ID have the same meaning in most cases. However, there are cases (cloud) where a plurality of exclusive areas correspond to one tenant 2, and the tenant ID and activation ID are distinguished.

This activation ID is attached to all operations performed on the workflow management device 1 from the user terminal device 3 belonging to a certain tenant 2. The input/output processing part 21 and workflow management part 22 of the workflow management device 1 allow access only to the exclusive area specified by the activation ID and ignore, reject, or invalidate access to another exclusive area. In this way, the activation ID creates an impression as if the workflow management device 1 existed for each tenant 2 while ensuring security among the plurality of tenants 2.

The workflow management part 22 may further divide an exclusive area for a tenant 2 into subareas so that there is a subarea for each workflow, assign an activation ID to a combination of the tenant 2 and a workflow, and associate the activation ID with a corresponding subarea of the exclusive area. The activation ID in the workflow information 31 (FIG. 2) is such an example.

### Workflow Participation Procedure

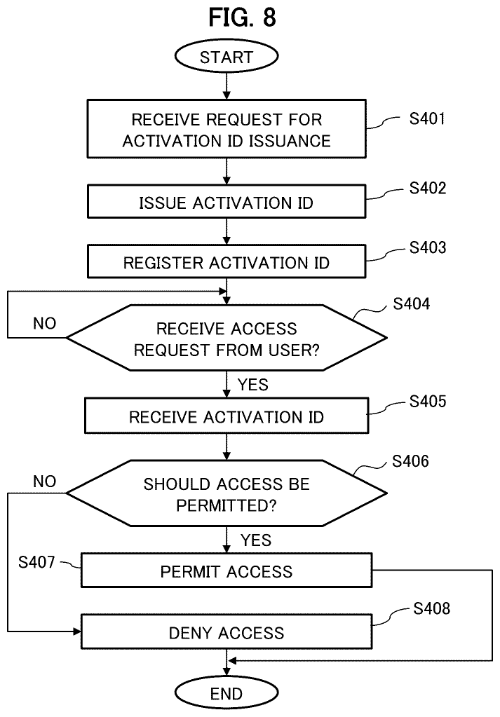

FIG. 8 is a flowchart of a workflow participation procedure.

In step S401, the workflow management part 22 of the workflow management device 1 receives an issuance request for an activation ID. More specifically, the workflow management part 22 receives an issuance request from any user terminal device 3 to issue an activation ID. At this stage, it is assumed that the workflow management unit 22 already knows the tenant ID of a tenant 2 to which the user terminal device 3 belongs and the flow ID of a workflow registered by the tenant 2.

In step S402, the workflow management part 22 issues an activation ID. More specifically, the workflow management part 22 issues an activation ID for a combination of the tenant ID and flow ID and sends the activation ID to a user terminal device 3 of a drafter. The activation ID may be encrypted, set with an expiration date, or have a password that may be changed at any time. Thereafter, the user terminal devices 3 of the tenant 2 to which the drafter is affiliated will share the one or more issued activation IDs.

The workflow management part 22 sets an exclusive area of the workflow management device 1 for each activation ID. From a viewpoint of effective utilization of resources, handling of increased data, or the like, the workflow management part 22 may disconnect the activation ID from a certain exclusive area and associate the activation ID with another exclusive area.

In step S403, the workflow management part 22 registers the activation ID. More specifically, the workflow management part 22 stores the issued activation ID in the workflow information 31 (FIG. 2).

In step S404, the workflow management part 22 determines whether an access request has been received from a user. More specifically, when the workflow management part 22 receives an access request to access the workflow management device 1 from any user terminal device 3 (step S404, “YES”), the workflow management part 22 proceeds to step S405. Otherwise (step S404, “NO”), the workflow management part 22 remains on standby.

In step S405, the workflow management part 22 receives an activation ID. More specifically, the workflow management part 22 prompts the user terminal device 3 that sent the access request to input an activation ID and receives the activation ID from the user terminal device 3.

In step S406, the workflow management part 22 determines whether access is to be permitted. More specifically, the workflow management part 22 determines whether all of the following conditions are satisfied.
A combination of the tenant ID and flow ID specified by the received activation ID is registered in the same record of the affiliation information 34 (FIG. 5).
The received activation ID and the flow ID specified by said activation ID are registered in the same record of the workflow information 31 (FIG. 2).
A record including the flow ID specified by the received activation ID is registered in the interlock information 32 (FIG. 3).
The record of the workflow information 31 that includes the received activation ID includes a drafter ID or an approver ID of the user who has sent the access request.

If all the conditions are met (step S406, “YES”), the workflow management part 22 proceeds to step S407. Otherwise (step S406, “NO”), the workflow management part 22 proceeds to step S408.

In step S407, the workflow management part 22 permits access. More specifically, the workflow management part 22 allows the user terminal device 3 that sent the access request to access the exclusive area specified by the activation ID that has been received in step S405. Subsequently, the workflow participation procedure ends. To “access” means to perform an operation on a document 5 stored in the exclusive area, or to perform a process of the workflow in the exclusive area.

In step S408, the workflow management part 22 denies the access. More specifically, the workflow management part 22 denies the user terminal device 3 that sent the access request from accessing any of the exclusive areas. Then, the workflow participation procedure ends.

### Effects of Embodiment

The workflow management device according to the present embodiment enables the following effects.
(1) The workflow management device may determine whether to deny an operation on a document due to an interlock.
(2) The workflow management device may set whether to deny an operation due to an interlock according to a type of operation or a user.
(3) The workflow management device may set whether to deny an operation due to an interlock according to a time period.
(4) The workflow management device may deny a viewing or revising of a document with an interlock.
(5) The workflow management device may notify a user that an operation has been denied due to an interlock.
(6) The workflow management device may be used by multiple organizations while security is ensured.

Note that the disclosure is not limited to the above-described embodiment and includes various modifications. For example, the above-described embodiment has been described in detail to make the description of the disclosure easy to understand. However, the disclosure may not be limited to having the entire configuration that has been described for the above-described embodiment. Further, a part of a configuration of one embodiment may be replaced with a configuration of another embodiment. Further, a configuration of one embodiment may be added to a configuration of another embodiment. Further, a part of a configuration of each embodiment may be deleted or replaced with another configuration. Further, a part of a configuration of each embodiment may be added with another configuration.

Further, each of the above-described components, functions, processing parts, processing means, or the like may be partially or entirely realized by hardware by designing, for example, an integrated circuit. Further, each of the components, functions, or the like described above may be realized by software with a processor interpreting and executing programs for realizing a respective function. Information such as a program, table, file, or the like that implement each function may be stored in a memory, a storage device such as a hard disk or a solid-state drive (SSD), or a non-transitory storage medium such as an IC card, SD card, or DVD.

Control lines and information lines that are considered necessary for explanation have been shown. Not all control lines and information lines that may be included in a product are necessarily shown. Almost all components may be considered interconnected.

An object of the disclosure is to manage multiple types of interlocks for a workflow in an organization.

According to the disclosure, multiple types of interlocks may be managed for a workflow in an organization.

1. A workflow management device comprising:
a storage; and
a processor configured to:
receive workflow information and interlock information, the workflow information being information on a workflow of a document from drafting to approval, and the interlock information being information that sets in advance whether an operation on the document is to be denied due to an interlock;
receive an operation on the document while the workflow is in progress based on the workflow information; and
determine whether the received operation is to be denied due to an interlock by referencing the interlock information, wherein
the storage is configured to store therein the workflow information, the interlock information, and the document in an area that has been separately allocated to the workflow and an organization to which a user is affiliated, and
the processor is configured to issue to the user an identifier that only allows access to the area that has been separately allocated to the workflow and the organization to which the user is affiliated, the identifier uniquely identifying a combination of the organization and the workflow.

2. The workflow management device according to claim 1, wherein
the interlock information sets whether an operation is to be denied due to an interlock according to a type of operation and a user.

3. The workflow management device according to claim 2, wherein
the interlock information sets whether an operation is to be denied due to an interlock according to a time period.

4. The workflow management device according to claim 3, wherein
the interlock information sets viewing or revising of the document as an operation that is to be denied with an interlock.

5. The workflow management device according to claim 4, wherein,
when the operation is denied due to an interlock, the processor is configured to display information that the operation has been denied due to an interlock to a user who has requested the operation.

6. A workflow management method comprising:
receiving workflow information and interlock information, the workflow information being information on a workflow of a document from drafting to approval, and the interlock information being information that sets in advance whether an operation on the document is to be denied due to an interlock;
receiving an operation on the document while the workflow is in progress based on the workflow information;
determining whether the received operation is to be denied due to an interlock by referencing the interlock information;
storing in a storage the workflow information, the interlock information, and the document in an area that has been separately allocated to the workflow and an organization to which a user is affiliated; and
issuing to the user an identifier that only allows access to the area that has been separately allocated to the workflow and the organization to which the user is affiliated, the identifier uniquely identifying a combination of the organization and the workflow.
